(19) United States
(12) Patent Application Publication
(10) Pub. No.: US 2003/0012181 A1
(43) Pub. Date: Jan. 16, 2003

(54) Simulating high-speed access on a low-bandwidth network connection

(76) Inventor: Andre The, Elk Grove, CA (US)

Correspondence Address: SAWYER LAW GROUP LLP, P.O. Box 51418, Palo Alto, CA, 94303, US

(21) Appl. No.: 10/113,370

(22) Filed: Mar. 29, 2002

Related U.S. Application Data
(60) Provisional application No. 60/280,012, filed on Mar. 30, 2001.

(51) Int. Cl. H04L 12/66

(52) U.S. Cl. 370/352; 370/392; 370/432

(57) ABSTRACT

A method and system for simulating high-bandwidth throughput on a low-bandwidth connection in a network is disclosed. The network includes at least one server and multiple client devices, where a first client device is connected to the server via the low bandwidth connection. Once a client device logs in to network and accesses a software application running on the server, only display data are transmitted to the client device. The display data is transmitted by breaking application display data for an object into subpackets, and then encapsulating the subpackets in a TCP/IP packet. The TCP/IP packet is provided with a header indicating a total number of packets in the package and a destination address of the client device receiving the packet, such that when the TCP/IP packet is routed across the network to the client device, only the header of TCP/IP packet needs to be read.

### CROSS-REFERENCE TO RELATED APPLICATION

This application is claiming priority under 35 U.S.C. §119(e) the benefit of provisional patent application Serial No. 60/280,012, filed Mar. 30, 2001.

### FIELD OF THE INVENTION

The present invention relates to client/server environments and more particularly to simulating high-speed access on a low-bandwidth network connection.

### BACKGROUND

In traditional client/server environments, a client device, such as a PC, downloads and processes data from a server over a network such as a LAN or the Internet. The server acts as a remote disk drive, and the client does all the processing. The data may represent a document file data that is stored on the server, but edited on the client, or the data may represent a web page that is downloaded to the client for display by a web browser. The time to process the data on the client is usually much less than the time it takes for the data to be downloaded from the server, such as when displaying a web page for example. Therefore, the speed at which the data is processed for use and/or for display is primarily limited by the bandwidth of the connection between the client and server. For example, consider a network where the clients run a database application and need to search a database stored on the server. Assuming the database has 100,000 records at 1,000 bytes per record, the server must send the entire 100MB file over the LAN to each client that performs a search. Not only will it take a long time to download the file, especially over a low-bandwidth connection, but transferring the file to each client can also bog down the network.

An improvement over the traditional client/server approach is a two-tier client/server in which application and database processing are done in the file server. In the database example, for instance, the client generates a SQL query and transmits it to the server. A DBMS in the server searches for records in the database and returns only the matching records to the client. If 50 records met the criteria in the 100,000-record example, only 50K would be transmitted over the LAN.

A newer paradigm is the three-tier client/server, or distributed computing network, where application processing is performed entirely on two or more servers, such as an application server or a database server, and only display data in the form of screen change information is sent to the client.

An example of three-tier client/server is Microsoft's Windows Terminal Services. Known officially as Windows NT 4.0, Terminal Server Edition, it is an option in NT that enables an application to be run simultaneously on a server by multiple users at different Windows PCs. The Windows 2000 counterpart of Terminal Server Edition is known as the Terminal Services option. Windows Terminal Server turns an NT server into a centralized, timeshared computer similar to old mainframes and terminals. The difference is that Windows provides a graphical interface, whereas mainframes provided only character-based interfaces. All the data processing (business logic) is performed in the server, and the client PCs display only the user interface and screen changes.

Windows Terminal Server uses MultiWin™ technology by Citrix Systems, Inc. to provide the timesharing of the application. Screen changes, however, are governed by Microsoft's RDP (Remote Desktop Protocol), which works only with Windows clients. RDP is the presentation services protocol that governs input/output between a Windows-only terminal client and Windows Terminal Server. Using Citrix's MetaFrame™ software on top of Terminal Server adds a protocol referred to as ICA that allows Terminal Server to support both Windows-based clients and a large number of and non-Windows-based client types, including OS/2, DOS, Linux, UNIX, Macintosh, and Java.

The user interface and screen changes are displayed via terminal emulation software installed on the client. The terminal emulation software, which is also provided by Citrix Systems, Inc., is a small software application that uses the ICA protocol to display the Windows user interface on the client and establishes and maintains the connection between the client and server running Terminal Services. The terminal emulation software transmits all input from the user to the server, such as keystrokes and mouse movements, and receives the output from the server such as application display data and print streams.

Although Terminal Services allows applications to perform efficiently over low-bandwidth connections because only the application display and user input is transmitted between the server and client, Terminal Services has several disadvantages. One disadvantage is that Terminal Services is limited to the Microsoft suite of applications on the server side. Therefore, legacy systems such as mainframe database applications used by large enterprises cannot be supported, nor can popular software applications from other vendors, such as Oracle®.

Another disadvantage is that Terminal Services only supports a small number of simultaneous users. Although Microsoft literature purports to support a number of simultaneous users, e.g., 100, it is believed that in practice that is number is much lower, e.g., 40. It has been observed that once this number of users is exceeded, the Microsoft Terminal Services server tends to crash. Obviously, this is an unacceptable result for enterprises running mission critical applications. If Terminal Services worked as advertised, Terminal Services servers would be ubiquitous, but adopting Terminal Services is not an easy deployment for companies because of these inherent drawbacks.

A further disadvantage of Terminal Services is that Terminal Services uses remote desktop protocol (RDP) to route data packets between the client and server. Each packet is designed to run on any public network and includes addressing information that allows routers to move the packets across the network. Unfortunately, the routers must open and read the addressing information from each packet, which for thousands upon thousands of packets is inefficient and hampers the speed at which the client receives the packets.

Although Microsoft Terminal Services running under RDP is able to conserve some bandwidth under certain conditions, under other conditions Microsoft Terminal Services running under RDP increases bandwidth. Running RDP transport to conserve bandwidth while working within the framework of Microsoft white papers is not a problem. The problem arises when one desires to use applications and configurations outside of the white papers, such as when running graphic intense application like Adobe photoshop, for instance. Graphic intense applications are not suited for the terminal services environment. What typically ends up happening, with plain vanilla Microsoft RDP, is that the bandwidth utilization is greater than if one were to setup a standard thick client-server setup. For example, if Microsoft RDP were to run at an average bandwidth utilization of 56 kbps while following the conditions set forth in the Microsoft white papers, graphic intense applications could actually take up to 768 kbps of bandwidth thoughout the duration of the RDP session. If the same application were to use a standard thick client-server configuration, the average sustained bandwidth during the thick connection would be 256 kbps. So rather conserving bandwidth using RDP under certain conditions, RDP actually utilizes more bandwidth.

As a further example, Microsoft for a video on demand application actually increases bandwidth utilization. If a user were to click on a Microsoft Media Streamed file set for 60 Kpbs, the RDP packet stream back to the requesting client increases to a packet flow of 6 Mbps.

Accordingly, what is needed is a method and system for simulating high-speed access on a low-bandwidth network connection. The present invention addresses such a need.

### SUMMARY OF THE INVENTION

The present invention provides a method and system for simulating high-bandwidth throughput on a low-bandwidth connection in a network. The network includes at least one server and multiple client devices, where a first client device is connected to the server via the low bandwidth connection. Once a client device logs in to network and accesses a software application running on the server, only display data is transmitted to the client device. The display data is transmitted by breaking application display data for an object into subpackets, and then encapsulating the subpackets in a TCP/IP packet. The TCP/IP packet is provided with a header indicating a total number of packets in the package and a destination address of the client device receiving the packet, such that when the TCP/IP packet is routed across the network to the client device, only the header of TCP/IP packet needs to be read.

In accordance with the present invention, addressing information is required only the header of the TCP/IP packet and is left out of the subpackets, making them smaller. Because the subpackets contain less information and no longer need to be read to be routed across the network, the speed of the network is increased.

### BRIEF DESCRIPTION OF THE DRAWINGS

FIG. 1 is a block diagram illustrating a private network for simulating high-speed access for client devices connected to the network with a low-bandwidth connection.

FIGS. 2A and 2B are flow charts illustrating the process for simulating high-speed access for client devices connected to the private network with a low-bandwidth connection.

FIG. 3 is a block diagram illustrating a detailed view of a data center.

### DETAILED DESCRIPTION OF THE INVENTION

The present invention relates to increasing data throughput on a private network over the Internet. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown but is to be accorded the widest scope consistent with the principles and features described herein.

The present invention provides a network that allows client devices to connect with a low bandwidth connection (e.g. 14.4 K up to a T1) and allows users of the devices to experience greater throughput and responsiveness than typically allowed by the connection speed, all without the use of the packet protocol named RDP. The present invention is implemented using a data center and three separate applications: 1) A service running on Terminal Server; 2) An application written for Terminal Server; and 3) A client side application. The first two applications are transparent to the user of the client device.

1) The Service Running on Terminal Server

This service is the gateway for the entire Server Farm. This service will reside on all Servers providing the Bandwidth conservation. The purpose of this service is to monitor packet types, MIME types, and the application layer of the OSI model. Under certain conditions predefined in the service, the service will redirect and change the essence of the data packet.

So for example, a UDP packet is requested. If terminal server were to process that packet and send it on via RDP, that original packet would grow to over 100× times its original size. This is completely opposite of the effect we are providing. The Service Gateway will apply In an RDP or ICA session, certain applications are identified as “Graphic Intense” Those applications and their associated packets are coded in the packet header. Each packet header contains information to allow the gateway to determine the packets purpose. If any part of these conditions or the packets stated purpose, then the coded packet headers are true then the gateway will know that session will have to be monitored for bandwidth utilization. Once the bandwidth threshold has grown beyond a standard client server connection, then the gateway will pass the packet directly to end user or requesting machine to be processed locally.

If it is determined the data packet is graphic intense is false, then the gateway will push the packet on to the terminal server If the packet header is such that it will work well with Terminal Sever, then we will allow the packet to be processed by Terminal Server. If the packet is not suitable for terminal server, then we will by pass terminal server and process the data locally at the client side. This way we can always determine the best possible method to process the packet. This will, in turn, insure the best utilization of the available bandwidth. If all conditions are true, then the technology allows for the best use of network utilization and available processor power. The service will then call the terminal server application for that user. That application takes all forwarded packets from the gateway. No packets from that point on use the Terminal Server.

2) The Application Written for Terminal Server

The terminal server application that we wrote now opens up a channel in the TCP/IP pipeline. Before in that pipeline, RDP and ICA packets were flowing. The terminal server application stops all traffic of RDP and ICA packets. The new data channel is now completely free of all noisy traffic. Then the terminal server application delivers whatever packet to the client application. It is in this data channel that the server application and client application can communicate. It can pass UDP, TCP/IP, multicast, and even VOIP. It is completely transparent to the user.

In contrast, the Microsoft and Citrix solution make absolutely no considerations for any traffic other than RDP and ICA. Our technology is packet, application, and environment independent.

Referring to the previous example, rather than sending a 6 Mbps packet flow, from something that started off at 60 Kbps, we are able to at least keep in the worst case the original size of the packet at 60 Kbps, and in the best case conserver 50% of the bandwidth on Video on Demand.

3) The Client Side Application

The client portion of the technology is very important. It is the application that binds all of the back-end technology into an interface for the user. The client side application allows for the utilization of all resources.

Microsoft and Citrix do not allow for the use of any hardware callable resource on the server side. This is on the server side. So for example if one decided to put a 128 MB AGP video card to process video (AutoCAD, Games) Terminal server will not allow Terminal Services use of the AGP video card. Rather instead, it creates a virtual video processor, that is processed with available on board RAM, calls to the CPU and calls to the motherboard. There are no callable routines that a permitted to use other on-board co-processing on the server side. Our technology allows for this to happen. The client side application is to interpret all type of packets and process the information. More importantly this data process flow allows for a server side push or a client side pull. The condition would be whether the client or server side can process the information better. For a graphic intense application, for example, the packet is passed on to the client machine for processing. By doing so, our client side application will be allowed to take advantage of available hardware present on the client machine. This could be anywhere from video cards, sound cards, and other peripheral devices. This will allow for virtual sessions to utilize all hardware functions that are available on the server. Once those conditions are met, then the data channel is prepared to transfer the data.

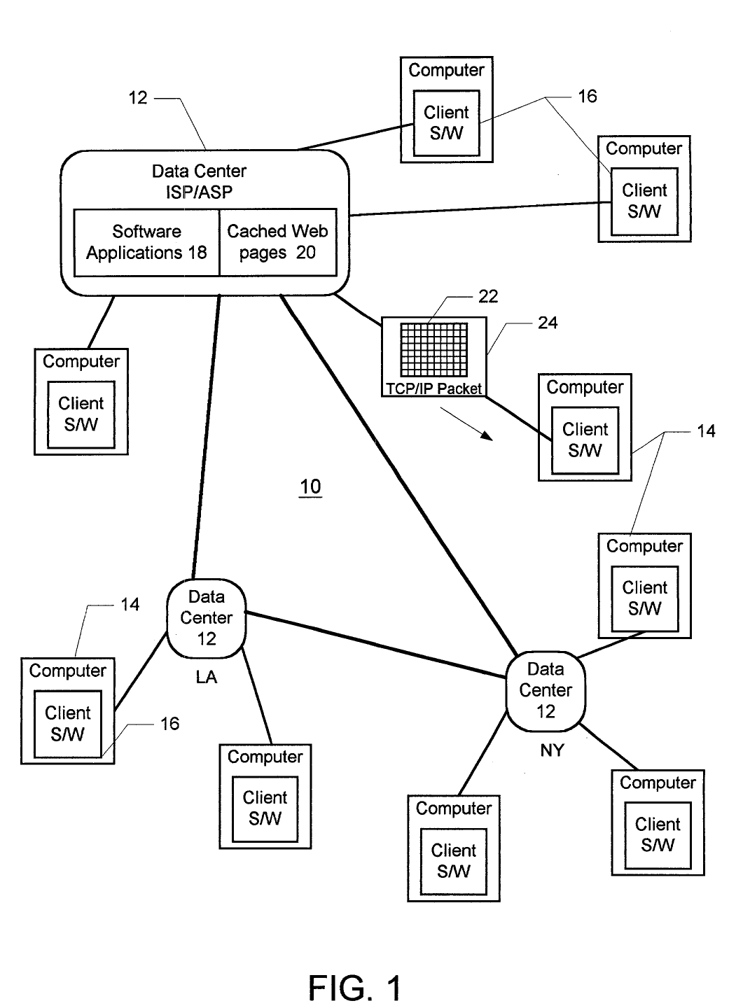

FIG. 1 is a block diagram illustrating a private network for simulating high-speed throughput for client devices connected to the network with a low-bandwidth connection. The private network 10 includes one or more data centers 12 that are accessible by client devices 14, preferably over a public network, such as the Internet.

A client device 14 may represent computers, PDAs, cellphones, or networks of computers. An electronic device becomes a client device 14 by the installation of client software 16 on the client device 14. The client software 16 is a small software application that displays a user interface on the client device 14 and establishes and maintains the connection between the client and the data center 12. The client software 16 transmits all input from the user to the data center 12, such as keystrokes and mouse movements, and receives the output from the server. In a preferred embodiment, the client devices 14 may run different types of operating systems including Windows, Mac OS, DOS, OS/2, UNIX, Linux, Java, Windows CE, Palm OS, and so on.

According to the present invention, each data center 12 acts as both an Internet service provider (ISP) for providing the client devices 14 with access to the Internet, as well as an application service provider (ASP) for hosting and executing software applications 18 for the client devices 14. The data center 12 may provide Internet service to the client devices 14 via a modem, ISDN, or by private line hookups (T1, fractional T1, and so on). Regardless of the connection speed, the present invention increases throughput of the connection and therefore simulates higher-speed access by decreasing the amount of information transferred from the data center 12 to the client devices 14.

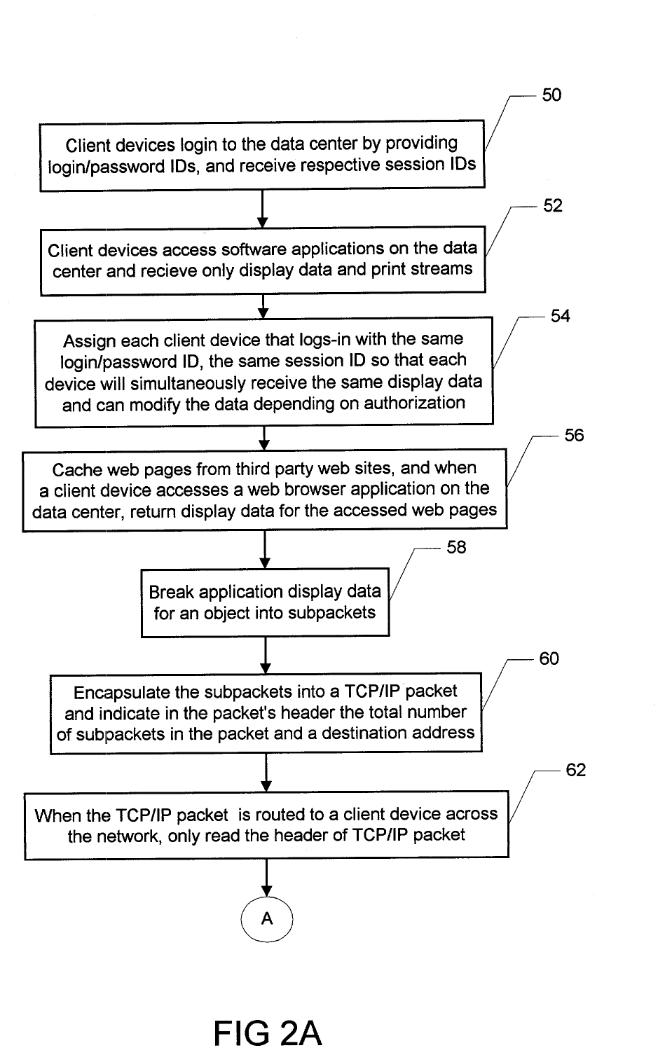

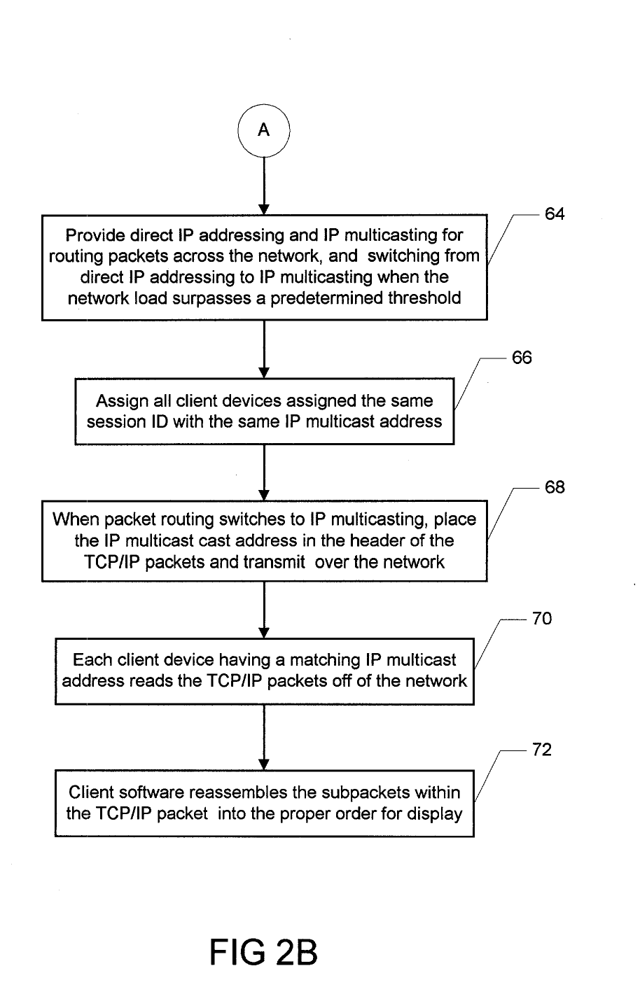

FIGS. 2A and 2B are flow charts illustrating the process for simulating high-speed access for client devices connected to the network with a low-bandwidth connection in accordance with a preferred embodiment of the present invention. Referring to both FIGS. 1 and 2, the process begins when the client devices 14 login to the data center 12 by providing login/password IDs, and in response, receive a session ID in step 50. Client devices 14 may then access the software applications 18 running on the data center 12, and in response, the data center 12 returns only display data and print streams to the client devices 14 in step 52. In a preferred embodiment of the present invention, the client software 16 uses the ICA protocol from Cirtrix Systems to allow a large variety of client device types to have timeshared access to applications and to provide the look and feel of Windows applications on the client devices 14. It should be readily recognized, however, that a custom protocol could also be used. If more than one client device 14 logs into the data center 12 using the same login/password ID, then the client devices 14 are assigned the same session ID and will simultaneously receive the same display data and can modify the data depending on authorization in step 54.

In one aspect of the present invention, the data center also caches web pages 20 from third party web sites so that when a client device 14 accesses a web browser application on the data center 12, only the display data for accessed web pages are returned to the client device in step 56. The data center 12 increases the throughput of a low-bandwidth connection because only display data of the applications 18 and web pages 20, and user input is transmitted between the data center 12 and client devices 14. According to the present invention, however, the amount of data transmitted from the data center 12 to the client devices 14 is further reduced to improve throughput as follows.

The application display data for an object is broken into subpackets 22 in step 58, where the package includes a primary packet, which contains a header that indicates a total number of packets in the package and a destination address of the client device receiving the packet. Such header information in the subpackets 22 is unnecessary, which makes the subpackets smaller than they otherwise would be. The subpackets 22 are then encapsulated in a TCP/IP packet 24, creating a package of subpackets, and the header information from the primary packet is copied into the header of the TCP/IP packet 24 in step 60.

When the TCP/IP packet 24 is routed to a client device 14 across the network 10, only the header of TCP/IP packet 24 needs to be read in step 62. Because an object's subpackets 22 are included in a TCP/IP packet 24 and the destination information can be determined from the TCP/IP packet 24, the present invention eliminates the need to read all of an object's subpackets 22 as the packets travel across the network 10, thereby increasing the speed of the network.

According to another aspect of the present invention, data throughput is further increased by providing two addressing modes for routing packet across the network 10, direct IP addressing and IP multicasting, where the addressing mode is switched from direct IP addressing to IP multicasting when the network load surpasses a predetermined threshold in step 64.

Direct IP addressing routes the TCP/IP packets 24 directly to individual client devices based on the client's IP address. Multicast addressing is a one-to-many transmission similar to broadcasting, except that multicasting implies sending to a list of specific users or client devices 14, whereas broadcasting implies sending to every client device 14. Multicasting is accomplished in the present invention by assigning all client devices 14 assigned the same session ID with the same IP multicast address in step 66. When packet routing switches to IP multicasting, the data center 12 places the IP multicast cast address in the header of the TCP/IP packets 24 and transmits the TCP/IP packets 24 over the network 10 in step 68. The TCP/IP packets 24 are then read off of the network 10 by each client device 14 assigned a matching IP multicast address in step 70. Employing IP multicasting allows a data stream that is to be shared by multiple users to be transmitted over the network 10 once and solely to those recipients that want to receive the stream. Once the TCP/IP packet 24 is received on the client device 14, the client software 16 reassembles the subpackets 22 within the TCP/IP packet 24 into the proper order for display in step 72. Since each multicasted TCP/IP packet is transmitted over the network once, but may be received by multiple client devices, network bandwidth is increased.

By transmitting only display data to client devices 14, eliminating the need for every subpacket 22 of the display data to be read, and by using IP multicasting to send one TCP/IP packet 24 to multiple recipients, the present invention simulates high-speed access to the Internet even though the client device 14 may be connected to the data center 12 with a low-bandwidth connection. This is true whether a user of client device 14 is accessing an application or surfing the web. The present invention also allows a user to spend less money on Internet connections. For instance, a corporation that establishes an account with the data center 12 may opt for only one 64 kb circuit at $300 per month, rather than using T1 connections at $2500 per month, but receive the same perceived data throughput.

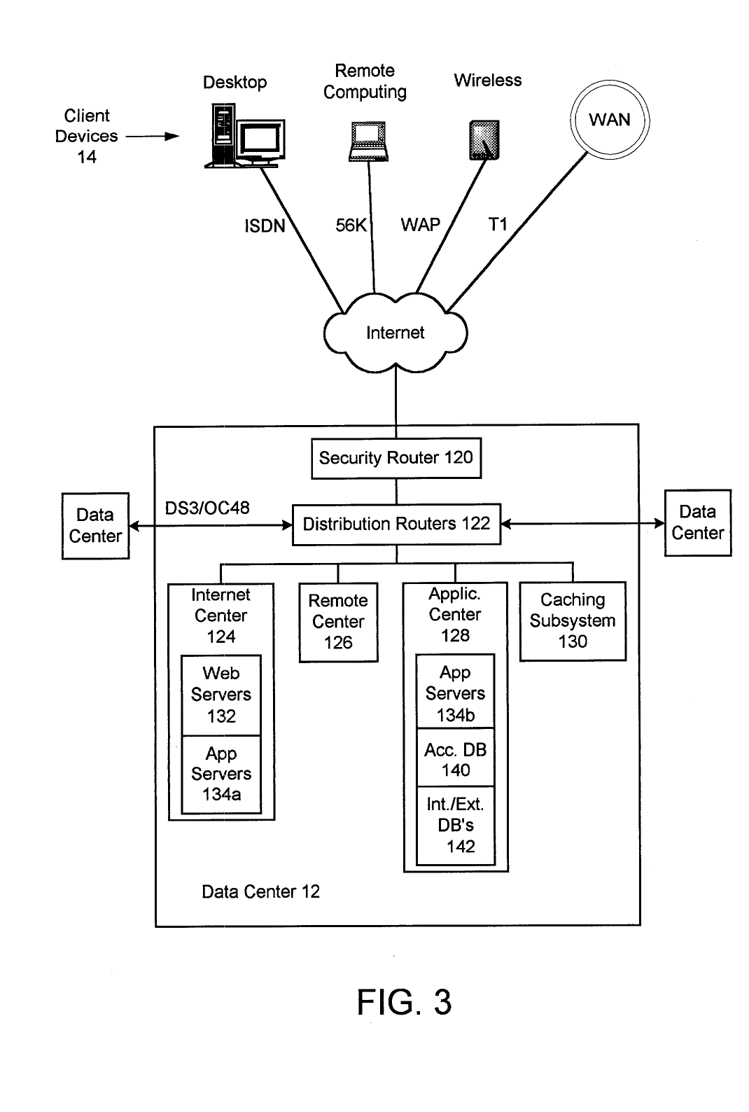

Referring now FIG. 3, a block diagram illustrating a detailed view of the data center 12 is shown. In a preferred embodiment of the present invention, the data center 12 includes a security router 120, multiple distribution routers 22, an Internet center 124, a remote center 126, an application center 128, and a caching subsystem 130. The Internet center 124 and the application center 128 include application servers 134a and 134b (collectively referred to as application servers 134) for executing browser-based applications and non-browser-based applications, respectively. The Internet center 124 further includes web servers 32 for providing the client devices 12 with network and Internet connectivity in conjunction with the remote center 126. The caching subsystem 130 is used to store copies of Web content from third party web sites for fast access by the client devices 14. With centers 124, 126, 128, and 130, the data center 12 provides client devices 14 with connectivity, processing of application data, and data organization that allows multiple users to synchronously access the data in a high-speed manner.

The remote center 126 allows the client devices 14 to connect to the data center 12 via many forms of connectivity, such as wireless, dial-up, data circuits, WAP, ISDN and so on, through any number of interexchange carriers (IXCs). An IXC provides interstate (long distance) communications services, which includes AT&T, MCI WorldCom, Sprint and many others.

In a preferred embodiment, the data centers 12 are connected through DS3 (Digital Signal) service, which provides 45 Mbps of data throughput, or OC48 (Optical Carrier), which provides 655 Mbps of data throughput. DS is a classification of digital circuits. DS technically refers to the rate and format of the signal, while the T designation refers to the equipment providing the signals. In practice, “DS” and “T” are used synonymously; for example, DS1 and T1, DS3 and T3. OC defines transmission by optical devices, and STS is the electrical equivalent.

Through the remote center 126, each client device 14 establishes a connection and logs on to the data center 12 through the security router 120 to gain access to the data center services. The security router 120 only allows requests from authorized client devices 14 of the network 10 and is responsible for denial service from non-members of the network 10 and from hackers.

Once communication is established, the Internet center 124 provides the client devices 14 with Internet access using the web servers 32, which may number in the hundreds. The applications servers 134a perform server side processing of web applications to browser-based client devices 14. In addition, the Internet center 124 further performs web hosting functions, e-mail, and video streaming applications.

The application center 128 includes multiple applications servers 134b that are capable of running a heterogeneous set of applications, which include not only Windows applications, but also non-Windows applications, including legacy applications. Examples of legacy applications include old IBM system 30 accounting applications and insurance applications, and UNIX-based systems, for instance. For legacy databases, the application servers 134 include bridge software that accesses the legacy database to post and fetch data that would be processed in the legacy environment, however, in a preferred embodiment, the user interface would be displayed on the client device 14 in the Windows environment. The present invention is an improvement over Microsoft's Terminal Services because many large enterprises have not yet migrated totally to the Microsoft Windows environment.

The application servers 134 interface with an account database 40 and with internal and external databases 42. The account database 40 stores user account information for each user, such as the user's account number, login/password IDs, session information, addresses, credit card numbers, and so on.

Databases 42 store client data that may either be uploaded to the data center 12 and stored internally, or the client data may be stored on corporate databases that are external to the data center 12. Because the data center 12 is a central location for client data, all devices connected under the same user account may access the same data. For example, assume that a corporation has offices all the country and that each office needs to have a copy of the corporate database. Instead of storing a copy of the corporate database locally at each office and synchronizing the data during the night, one copy the corporate database may access to and/or stored by the data center 12. Once a corporate account has been set up, employees of the corporation could access the data center 12 using PCs, handhelds, and wireless devices, login under the corporate account, and gain access to the corporate data.

The caching subsystem 130 allows the data center 12 to store content from specified third party web sites in a central location within the network 10 for serving to the client devices 14 on demand. The caching subsystem 130 is needed because not all web servers are fast. Third party web sites that expect large volumes of hits in a short time period, such as for a live broadcast for example, can cache the content on the data center 12 and the data center 12 can serve the content over the network 10 as described herein to allow members of the network to have immediate access to the content. Thus, the this aspect of the present invention takes the load off the public Internet, which suffers from routing latency and packet loss.

Each data center 12 is connected to other data centers 12 through the distribution routers 22, which primarily synchronize the application servers with client devices 14. The distribution routers 22 allow the data center 12 to appear to the client devices 14 as in ISP/ASP on the circuit side, an interexchange point, and a network access point. An interexchange point and a network access point (NAP) TO are junction points where major Internet service providers interconnect to exchange traffic with each other. The distribution routers 122 allow the data center 12 to act as an interexchange point (IEA) by routing packets from one carrier to another in times of heavy load. By acting as an interexchange point, the data center 12 allows client devices 14 to connect with any other Internet provider (MSN, AOL, EarthLink, etc.)

Since the network 10 only has certain geographical access points to the data centers 12, most of the network traffic is routed internally across the distribution routers 22. The distribution routers 22 route packets 24 to appropriate data centers 12 since the applications 18 are not duplicated at the different data centers. For example, a client running an application 18 from New York and a second client running the same application 18 from San Francisco would be routed to the same data center 12 that contains the application 18.

When a client device 14 logs onto the data center 12 and accesses a particular application 18, one or more servers 134 perform all processing of the application 18 and the data and only transmit screen display data and print streams to the client device 14. The distribution routers 22 receive display data objects from the servers 134 and 36 and break each object down into multiple subpackets 22 that are stripped of full header information to make room for more data and to make transportation of the subpackets 22 more efficient. Instead of transmitting each subpacket 22 separately, each of which would have to be read by each router it passes by on the network 10, the distribution routers 22 encapsulate all the subpackets 22 of a particular object as one TCP/IP packet 24, and insert into the header of the TCP/IP packet 24 the total number of subpackets 22 within the TCP/IP packets 24, and the address of the source and destination for all the subpackets 22.

The distribution routers 22 normally route the TCP/IP packets 24 to the recipient client device 14 using direct IP addressing. But when the network 10 load reaches a predetermined threshold, the addressing scheme is switched to IP multicasting. Once this occurs, the IP multicast address is also inserted into the header of the TCP/IP packet 24.

Although most frame-based networks, such as Ethernet, can communicate in three modes: unicast, broadcast, and multicast, multicasting is preferred for the following reasons. Unicast, the most common, is simply point-to-point communication between two devices on the network, such as a PC and a file server. Unicasts are appropriate for the majority of applications, but they fall short in several collaboration software areas. For example, unicasts would not be appropriate for a corporate training exercise for which an instructor is using a collaborative shared-whiteboard application to send in real-time an instructor-station screen to 35 student PCs.

With unicasts, screen-update information from the instructor's station needs to be transmitted separately to each student PC, resulting in noticeable delays-even on shared media-as each update is sent over the network 35 times. This is clearly a waste of bandwidth, as the information being transmitted to every student station is a duplicate of what was sent to the previous station. It would be far better if the 35 student stations all could “listen” to the instructor station at the same time, and if an update is transmitted just once.

A network broadcast would achieve this. A broadcast allows one station on the network to simultaneously talk to all devices contained in the same broadcast domain, or subnet. But broadcasts have their failings as well. For example, a video server can place a live video feed, perhaps a CNN newscast, onto a campus network so that any desktop user could tune in.

But to let a user join in, the broadcasts must be permitted to cross subnet boundaries. In this scenario, broadcasts would use precious bandwidth on subnets throughout the campus. Furthermore, a broadcast requires all client devices 14 and internetworking equipment (such as routers and switches) to receive and utilize CPU cycles to process the packet, even if only a tiny minority of client devices 14 want to receive the broadcast information in the first place.

Using IP multicasting in accordance with the present invention, the data center 12 can transmit to multiple client devices 14 simultaneously, but unlike the “one or everyone” possibilities with unicasts and broadcasts, the distribution routers 22 can specify a specific group of client devices 14 to receive the information. This is accomplished by transmitting to the IP multicast address, which can be conceptualized as a TV channel. Client devices 14 assigned the IP multicast address simply “tune in” to data streams having the same multicast address. If, for example, client devices 14 on only two out of 40 subnets receive a CNN feed, for instance, bandwidth is not utilized on the remaining 38 subnets.

There are three components that are required to allow IP multicasting to occur: Layer 3-to-Layer 2 translation, dynamic membership control and multicast-aware routing. Each requires cooperation and support from the vendors supplying the operating system or TCP/IP stack, network adapters and infrastructure equipment, particularly routers and switches.

Layer 3-to-Layer 2 Translation All network protocols need a method to translate the IP network address ISO/OSI Layer 3 into a hardware/media address (Layer 2), such as an Ethernet Media Access Control (MAC) address.

Groups of client devices 14 representing a multicast group are identified by an IP multicast address. Class “D” IP addresses are reserved for multicast traffic. Class “D” IP addresses are those beginning with “1110” for the first four bits, which means addresses 224.0.0.0 through 239.255.255.255. Each address can be considered a “channel” by which groups of hosts interested in receiving the same content can be identified; perhaps a network administrator would broadcast CNN video on 229.15.15.30, and CNBC video on 229.15.15.31. Various videoconference and/or collaborative session groups also would be identified via their own IP multicast address.

Translation between a given IP multicast address and an Ethernet MAC address may be accomplished by mapping the IP multicast addresses directly into an Ethernet MAC address by dropping the low-order 23 bits of the IP address into the low-order 23 bits of the Ethernet multicast address (hex 01-00-5E-00-00-00.)

The TCP/IP stacks on each client device 14 must be IP multicast-aware to understand the significance of this special range of IP addresses, and to program the client device's network adapter to properly receive requested multicast addresses. Practically all Ethernet adapters can be programmed to listen to a few Ethernet MAC addresses, specifically their own as well as the MAC Ethernet broadcast address.

In a preferred embodiment, Ethernet adapters ideally suited for use in an IP multicast environment let several additional MAC addresses be programmed in by the TCP/IP stack, enabling the client device 14 to listen in on several multicast groups simultaneously without receiving an entire general range of MAC addresses. This would force the client device 14's CPU to spend cycles weeding out the undesired packets 24. In the PC arena, the adapter's hardware may have this capacity, but the implementation could be hindered by poor Network Driver Interface Specification (NDIS) or Open Data-Link Interface (ODI) drivers.

Dynamic Membership Control Part of the appeal of IP multicasting is that the multicast traffic is present only on those subnets where one or more hosts is actively requesting it. Before transmitting a given multicast stream onto a subnet, a router needs to know if any client devices 14 on that subnet want to receive that multicast. Via the Internet Group Management Protocol (IGMP, RFC 1112), client devices 14 dynamically inform a multicast-aware router of any multicast sessions in which they want to participate. If no hosts on a given subnet register via IGMP for a multicast session, the traffic transmitted to that multicast address will not be routed onto that particular subnet, thereby preserving bandwidth.

IGMP version 1 is most common. IGMP version 2 is an IETF draft, but is rapidly gaining acceptance. Among its improvements, IGMP 2 lets a host inform a multicast-aware router when it no longer wants to receive traffic for a given multicast group. In IGMP 1 implementations, hosts cannot explicitly exit a multicast group, but instead simply stop reporting interest in a given group. The router then halts retransmission of the traffic for that group upon expiration of a time-out mechanism.

IGMP client support needs to be built into your host TCP/IP stack (it is present in Microsoft's TCP/IP-32, Win95 and Windows NT 3.51+ stacks). In a preferred embodiment, the routers support IGMP. Examples of multicast routing protocols include Distance Vector Multicast Routing Protocol (DVMRP), Multicast Open Shortest Path First (MOSPF) and Protocol-Independent Multicast (PIM). Multicast-aware routers use these protocols to take the group membership information learned from an IGMP communications to dynamically build multipoint route trees, which map paths from a sender to all receivers.

In a preferred embodiment, DVMRP that builds a distribution tree when a router receives a multicast packet 24 by flooding the packet 24 out to all interfaces except for the one that received the incoming packet. This results in the packet 24 reaching all subnets in the internetwork. Subsequently, routers that have no need to receive a particular multicast group (no hosts on their subnets have requested the group via IGMP) can send a “prune” message back upstream to cut off traffic where it is not required.

A method and system for simulating high-bandwidth throughput on a low-bandwidth network connection has been disclosed. The present invention has been described in accordance with the embodiments shown, and one of ordinary skill in the art will readily recognize that there could be variations to the embodiments, and any variations would be within the spirit and scope of the present invention. In addition, software written according to the present invention may be stored on a computer-readable medium, such as a removable memory, or transmitted over a network, and loaded into the servers and/or client devices for execution. Accordingly, many modifications may be made by one of ordinary skill in the art without departing from the spirit and scope of the appended claims.

What is claimed is:

1 A method for simulating high-bandwidth throughput on a low-bandwidth connection in a network, the network comprising at least one server and multiple client devices, wherein a first client device is connected to the server via the low bandwidth connection, the method comprising the steps of:
(a) allowing client devices to login to network and to access software applications running on the server; and
(b) transmitting only display data to the client devices, wherein the display data is transmitted by;
(i) breaking application display data for an object into subpackets,
(ii) encapsulating the subpackets in a TCP/IP packet, and
(iii) providing the TCP/IP packet with a header indicating a total number of packets in the package and a destination address of the client device receiving the packet, such that when the TCP/IP packet is routed across the network to the client device, only the header of TCP/IP packet needs to be read, thereby eliminating the need to read all of an object's subpackets and increasing the speed of the network.

2 The method of claim 1 wherein client devices are logged into the server by supplying a login/password ID and are assigned a session ID, the method further including the step of:
(c) if more than one client device logs into the server using the same login/password ID, then assigning those client devices the same session ID, such that those client devices receive the same display data.

3 The method of claim 1 further including the steps of:
(c) caching web pages from third party web sites so that when a client device accesses a web browser application on the server, only the display data for accessed web pages are returned to client device.

4 The method of claim 1 further including the step of:
(c) increasing data throughput by providing two addressing modes for routing packet across the network, direct IP addressing and IP multicasting, where the mode is switched from direct IP addressing to IP multicasting when a network load surpasses a predetermined threshold.

5 The method of claim 4 wherein step (c) further includes the steps of:
(i) assigning all client devices assigned a same session ID with a common IP multicast address;
(ii) when packet routing switches to IP multicasting, placing the IP multicast cast address in the header of the TCP/IP packets and transmiting the TCP/IP packet over the network;
(iii) reading TCP/IP packet off of the network by each client device assigned a matching IP multicast address;
(iv) once the TCP/IP packet is received on each client device, reassembling the subpackets within the TCP/IP packet into the proper order for display, wherein TCP/IP packet is transmitted over the network once, but may be received by multiple client devices, thereby increasing network bandwidth.

6 A method for simulating high-bandwidth throughput on a low-bandwidth connection in a network, the network comprising at least one server and multiple client devices, wherein a first client device is connected to the server via the low bandwidth connection, the method comprising the steps of:
(a) running heterogeneous applications on the server for access by the client devices, the client devices running different operating systems;
(b) transmitting only application display data and user input between the server and a first client device by,
(i) breaking the application display data into a package of packets, wherein the package includes a first packet containing a header that indicates a total number of packets in the package and a destination address of the first client, and
(ii) sending the package of packets to the first client through a router, such that when the packets are sent through the router, the router reads the header in the first packet to determine the destination address for all of the packets in the package, thereby eliminating the need for the router to read all of the packets and increasing throughput of the network.

7 A system for simulating high-speed access on a private network connected over the Internet, comprising:
a plurality of client devices coupled to the private network, wherein a first portion of the client devices are browser-based and a second portion of the client devices are non-browser-based; and
at least one data center coupled to the private network, the data center including,
an Internet center for providing the client devices with network and Internet connectivity via web servers, the internet center further including a first set of application servers for executing browser-based applications the for browser-based clients,
an application center including a second set of application servers for executing heterogeneous non-browser-based applications for the non-browser-based clients,
a caching subsystem for storing copies of web content from third party web sites for access by the client devices,
a plurality of distribution routers, the distribution routers for accepting data objects from the application servers and the caching subsystem and transmitting only application display data to the client devices by
(1) breaking each data object into a plurality of subpackets,
(2) breaking application display data for an object into a package of subpackets,
(3) encapsulating the package of subpackets as a TCP/IP packet, and
(4) providing the TCP/IP packet with a header indicating a total number of packets in the package and a destination address of the client device receiving the packet, such that when the TCP/IP packet is routed across the network to the client devices, only the header of TCP/IP packet needs to be read, thereby eliminating the need to read all of an object's subpackets and increasing the speed of the network.
